(19) United States
(12) Patent Application Publication
(10) Pub. No.: US 2014/0374507 A1
(43) Pub. Date: Dec. 25, 2014

(54) Sport-Type Multifunctional Spray Mineral Water Bottle

(71) Applicant: Sun Solutions LTD., Guangdong (CN)

(72) Inventor: Chang Ho CHANG, Taoyuan City (TW)

(21) Appl. No.: 14/484,560

(22) Filed: Sep. 12, 2014

Related U.S. Application Data
(62) Division of application No. 12/912,882, filed on Oct. 27, 2010, now Pat. No. 8,833,677.
Application No. 12/912,882 is a continuation-in-part of application No. 12/696,047, filed on Jan. 28, 2010, now abandoned.
Application No. 12/696,047 is a continuation-in-part of application No. 12/757,202, filed on Apr. 9, 2010, now Pat. No. 8,662,419.
Application No. 12/757,202 is a continuation-in-part of application No. 12/912,426, filed on Oct. 26, 2010.

(30) Foreign Application Priority Data
Oct. 22, 2010 (CN) 201010515802.8

(51) Int. Cl. A45F 3/20; B05B 11/04; A45F 4/00

(52) U.S. Cl. CPC A45F 3/20; A45F 4/00; B05B 11/048
USPC 239/327; 239/444; 222/482

(57) ABSTRACT

The invention discloses a sport-type multifunctional spray mineral water bottle, including cap body, spray means, drink means and water locking means. The invention can ensure normal drinking of mineral water as well as carry out spray drinking of water by means of squeezing the bottle body to transform bottle body and increase the pressure inside the bottle, thus making water to enter inlet from the outlet of water locking means on the cap, and to enter the atomizing channel through the water channel, finally to be sprayed from the spray aperture. Furthermore, in the open air or in the dusty and hot environment, you can place the mineral water bottle upside down, put the nozzle to face your body or surrounding, and squeeze the bottle body to spray, thus reducing surrounding temperature, as well as subsiding dust by combining dust and spray to make you feel cool, fresh and comfortable.

### CROSS REFERENCE TO RELATED APPLICATIONS

This application is a divisional application of U.S. patent application Ser. No. 12/912,882, entitled “SPORT-TYPE MULTIFUNCTIONAL SPRAY MINERAL WATER BOTTLE” filed on Oct. 27, 2010 and published as US 2011/0180630 A1, which is based upon and claims the benefit of priority from Chinese Patent Application No. 201010515802.8 filed on Oct. 22, 2010 in the People's Republic of China. Each of the above listed applications is hereby incorporated by reference herein as if set forth in its entirety.

### BACKGROUND

1. Technical Field

The invention relates to sport-type mineral water bottles, especially refers to a sport-type mineral water bottle with merits of spraying and drinking for outdoors.

2. Description of Related Art

The common mineral water bottle includes the cap body which is screwed with the mineral water bottleneck, and the cap body is matched with mineral water bottleneck by means of liquid-tight fit. When you want to drink the mineral water in the bottle, you remove the cap and directly drink the water. This type of cap is used for sealing the mineral water inside the bottle body, and anti-fake function as well. This type of cap has simple functions so that the mineral water bottle matched with the cap has simple functions as well, which cannot satisfy the demands of daily life of people.

Presently the mineral water, which is taken outside the home, is mainly used for drinking When it is extremely hot or when you watch football in a stadium in the summer heat, you may want to spray the mineral water directly to your face or head to reduce temperature. However, if pouring mineral water, you may waste too much water and it cannot satisfy your demands due to insufficient water. In addition, temperature reduction effect is limited by this type of method and surrounding air cannot be improved if it is dusty. Therefore the conventional cap needs to be modified and perfected.

### SUMMARY

Aiming at the shortcomings above in existing technology, the invention is to provide a spraying mineral water bottle for drinking or to adjust the air environment surrounding the human body by spraying.

For achieving the objective above, this invention adopts the following technical solution:

A mineral water bottle comprises an elastic deformation bottle and a spray mineral water bottle cap. The spray mineral water bottle cap comprises a cap body, a drink means, a spray means, and a water locking means. The cap body is secured on a bottleneck of the mineral water bottle and covering an open of the mineral water bottle, The cap body defines an outlet aperture on an end face of the cap body. The drink means comprises a movable rubber plug, and the cap body defines a water outlet, and the movable rubber plug moves along the water outlet to open or close the water outlet. The spray means is located at the cap body, water inside the elastic deformation bottle flows through the outlet aperture of the cap body and sprays out via the spray means. The water locking means comprises a fixing part fixed with the cap body and a movable part engaging with the fixing part. The movable part rotates relative to the fixing part back and forth to achieves the opening or closing of the spray means. The fixing part of the water locking means comprises a cylindrical protuberance located on an interior of a bottom of the fixing part. The cylindrical protuberance engages with the bottom of the movable part of the water locking means.

The fixing part defines a first outlet, and the movable part defines a first inlet corresponding to the first outlet of fixing part, and defines a receiving space securing the spray means by way of interference fit; and the movable part rotates relative to the fixing part back and forth to result the first outlet of the fixing part to align the first inlet of the movable part or interleaving between the first outlet of the fixing part and the first inlet of the movable part, thus achieving the opening or closing of the spray means.

The fixing part of the water locking means comprises a tube located axially in the center of the cap body, and a bottom of the tube is sealed, the first outlet is defined on a sidewall of the tube adjacent to the bottom of the tube; a bottom of the movable part is sleeved in the tube, and wherein the movable part rotates relative to the tube, the first inlet of the movable part is located on the bottom of the movable part, and corresponds to the first outlet of the tube; and when the movable part rotates relative to the fixing part to result the first outlet to communicate with the first inlet, the spray means is opened, and when the first outlet is staggered with the first inlet, the spray means is closed.

The tube defines an annular groove on an inner wall of the tube, and the movable part comprises an annular protuberance engaging with the annular groove on the inner wall of the tube of the fixing part.

The movable part of the water locking means is in a shape of a right angle, and comprises a first connecting tube in a vertical direction, and a second connecting tube in a horizontal direction, and the first connecting tube is integrated with the second connecting tube; and the first connection tube is connected to the fixing part of the water locking means by means of liquid-tight fit, the movable part rotates relative to the fixing part around an axis of the first connecting tube; and the receiving space is located on the second connecting tube.

An on-off position means is located on an end surface of the cap body, and the on-off position means comprises a pair of position blocks respectively fixing the spray means on 0° and 90° positions, the pair of positioning blocks are configured to fix the water locking means in an open position and in a close position, respectively, and each positioning block comprises a cambered surface matched with the second connecting tube.

A limiting protuberance is disposed on one side of a bottom of the cambered surface of one of the positioning blocks, and the one of the positioning blocks corresponds to the close position of the water locking means, and the limiting protuberance fixes the water locking means in the close position.

The spray means comprises an atomizing spool and a nozzle, at least two water channels are defined on the outer wall of the atomizing spool, and atomizing channels are defined on an end face of the water channels, and correspond to the water channels; and the nozzle defines a cavity to receive the atomizing spool, and a spray aperture is defined on an end face of the nozzle; and the atomizing spool matches with the cavity of the nozzle by interference fit, and the atomizing channels communicate with the spray aperture of the nozzle.

A supporting bracket projects from an interior surface of the second connecting tube, and extends into the cavity of the nozzle to support the atomizing spool.

The drink means further comprises a water outlet means fixed with the cap body, a gap is formed between the water outlet means and the movable rubber plug, and the movable rubber plug comprises a plastic wall, and when the movable rubber plug moves up along the water outlet means, the plastic wall of the movable rubber plug connects with the water outlet, and the water inside the elastic deformation bottle pours out along the gap.

A mineral water bottle comprises an elastic deformation bottle and a spray mineral water bottle cap. The spray mineral water bottle cap comprises a cap body, a drink means, a spray means and a water locking means. The cap body is secured on a bottleneck of the mineral water bottle and covers an open of the mineral water bottle. The cap body defines an outlet aperture on an end face of the cap body. The drink means comprises a movable rubber plug. The cap body defines a water outlet, and the movable rubber plug moves along the water outlet to open or close the water outlet. The spray means is located at the cap body, wherein water inside the elastic deformation bottle flows through the outlet aperture and sprays out via the spray means. The water locking means comprises a fixing part fixed with the cap body, and a movable part engaging with the fixing part. The movable part rotates relative to the fixing part back and forth to achieve the opening or closing of the spray means. An on-off position means is located on an end surface of the cap body, and the on-off position means comprises a pair of position blocks respectively fixing the spray means on 0° and 90° positions, the pair of positioning blocks are configured to fix the water locking means in an open position and in a close position, respectively, and wherein each positioning block comprises a cambered surface matched with a portion of the movable part exposed out of the cap body. A limiting protuberance is disposed on one side of a bottom of the cambered surface of one of the positioning blocks, and the one of the positioning blocks corresponds to the close position of the water locking means, and the limiting protuberance fixes the water locking means in the close position.

The fixing part defines a first outlet; and wherein the movable part defines a first inlet corresponding to the first outlet of fixing part, and a receiving space securing the spray means by way of interference fit; and wherein the movable part rotates relative to the fixing part back and forth to result the first outlet of the fixing part to align the first inlet of the movable part or interleaving between the first outlet of the fixing part and the first inlet of the movable part, thus achieving the opening or closing of the spray means.

The fixing part of the water locking means comprises a tube located axially in the center of the cap body, and a bottom of the tube is sealed , the first outlet is defined on a sidewall of the tube adjacent to the bottom of the tube; a bottom of the movable part is sleeved in the tube, and wherein the movable part rotates relative to the tube, the first inlet of the movable part is located on the bottom of the movable part, and corresponds to the first outlet of the tube; and wherein when the movable part rotates relative to the fixing part to result the first outlet to communicate with the first inlet, the spray means is opened, and when the first outlet is staggered with the first inlet, the spray means is closed.

The tube defines an annular groove on an inner wall of the tube, and the movable part comprises an annular protuberance engaging with the annular groove on the inner wall of the tube of the fixing part.

The movable part of the water locking means is in a shape of a right angle, and comprises a first connecting tube in a vertical direction, and a second connecting tube in a horizontal direction, and the first connecting tube is integrated with the second connecting tube; and wherein the first connection tube is connected to the fixing part of the water locking means by means of liquid-tight fit, the movable part rotates relative to the fixing part around an axis of the first connecting tube; and wherein the receiving space is located on the second connecting tube, and the cambered surface of each positioning block matches with the second connecting tube.

The spray means comprises an atomizing spool and a nozzle, at least two water channels are defined on the outer wall of the atomizing spool, and atomizing channels are defined on an end face of the water channels, and correspond to the water channels; and wherein the nozzle defines a cavity to receive the atomizing spool, and a spray aperture is defined on an end face of the nozzle; and wherein the atomizing spool matches with the cavity of the nozzle by interference fit, and the atomizing channels communicate with the spray aperture of the nozzle.

A supporting bracket projects from an interior surface of the second connecting tube, and extends into the cavity of the nozzle to support the atomizing spool.

The drink means further comprises a water outlet means fixed with the cap body, a gap is formed between the water outlet means and the movable rubber plug, and the movable rubber plug comprises a plastic wall, and wherein when the movable rubber plug moves up along the water outlet means, the plastic wall of the movable rubber plug connects with the water outlet, and the water inside the elastic deformation bottle pours out along the gap.

The fixing part of the water locking means comprises a cylindric protuberance located on an interior of a bottom of the fixing part, and wherein the cylindric protuberance engages with the bottom of the movable part of the water locking means.

By adopting the above structure, with the coordination of the elastic mineral water bottle and the bottle cap, the spray mineral water of the invention can ensure normal drinking of mineral water as well as carry out spray drinking of water by means of squeezing the bottle body to transform bottle body and increase the pressure inside, thus making water to enter inlet from the outlet of water locking means on the cap, and to enter the atomizing channel through the water channel, finally to be sprayed from the spray aperture. Furthermore, in the open air or in the dusty and hot environment, you can place the mineral water bottle upside down, put the nozzle to face your body or surrounding, and squeeze the bottle body to spray, thus reducing surrounding temperature, as well as subsiding dust by combining dust and spray to make you feel cool, fresh and comfortable. This invention features in simple structure and strong practicability, so it has promising market prospect.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is the structure drawing of the embodiment 1 of the invention;

FIG. 2 is the structure drawing of the mineral water bottle cap of FIG. 1;

FIG. 3 is the B-B cutaway view of FIG. 2;

FIG. 4 is the structure drawing of the embodiment 2 of the invention;

FIG. 5 is the cutaway view of the bottle cap of FIG. 4;

FIG. 6 is an enlarged view of the bottle cap of FIG. 5;

FIG. 7 is the structure drawing of the embodiment 3 of the invention.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Further explanation to the invention is stated below combining with the attached figures:

### Embodiment 1

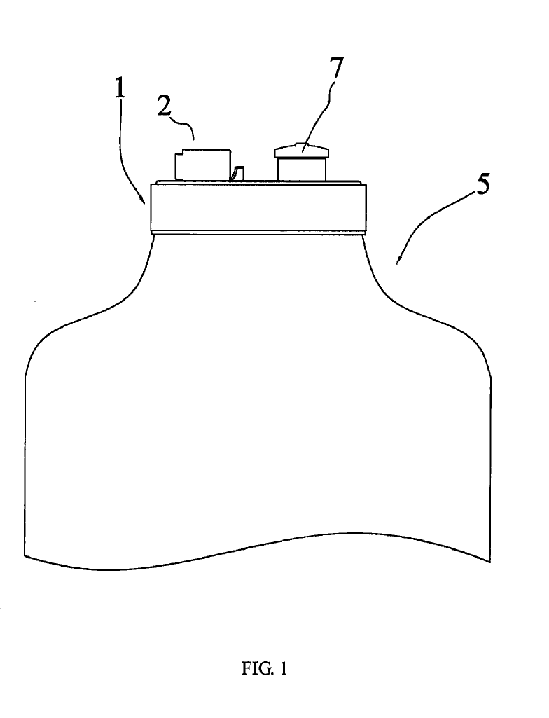

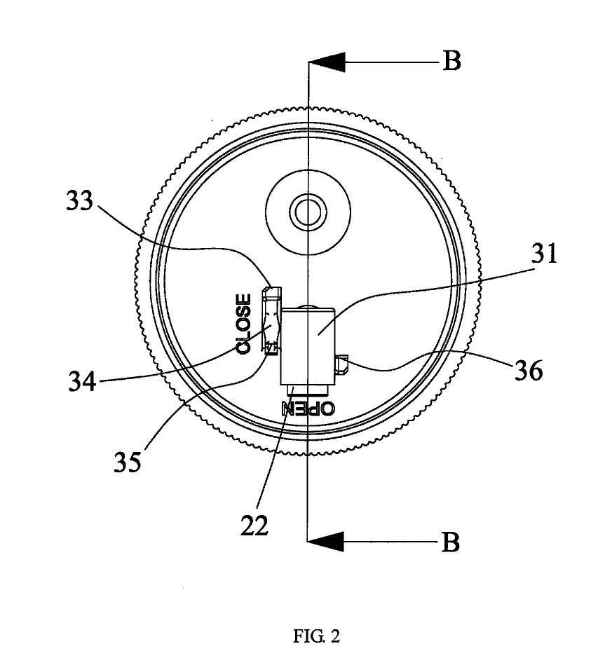

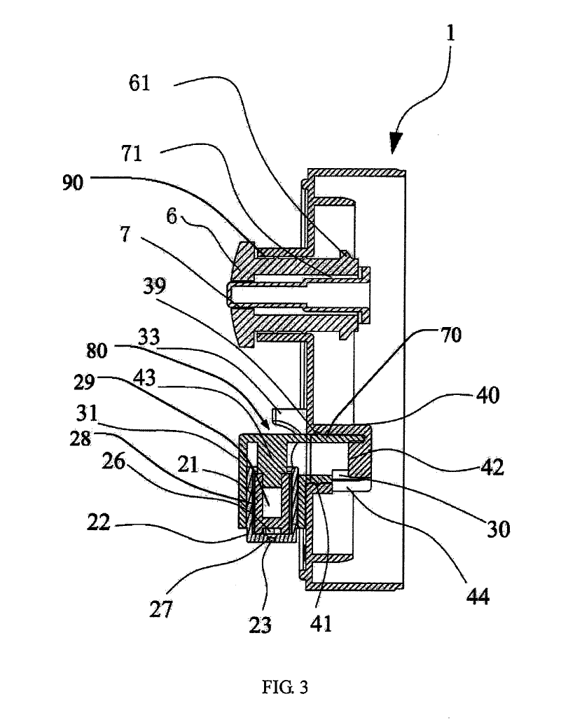

With reference to FIGS. 1-3, a sport-type multifunctional spray mineral water bottle includes an elastic deformation bottle 5 and a spray mineral water bottle cap. The spray mineral water bottle cap includes a cap body 1, a spray means 2, a drink means, and a water locking means. The cap body 1 and mineral water bottleneck are connected by means of liquid-tight fit, and a water outlet 90 is disposed on the end face of cap body 1. The cap body 1 is matched with mineral water bottleneck by means of liquid-tight fit, and an outlet aperture is disposed on the end face of cap body 1. The spray means 2 includes atomizing spool 21 and nozzle 22, and at least two water channels 28 are disposed on the outer wall of atomizing spool 21. The number of water channels 28 can be increased pursuant to the water volume. An atomizing channel 26 corresponding to the water channels 28 is disposed on the end face of atomizing spool 21 corresponding to the water channels 28, and the water channels 28 and atomizing channel 26 are connected by means of two connecting channels. A cavity 29 is disposed in nozzle 22 to hold atomizing spool 21, and a spray aperture 23 is disposed on the end face of one end of nozzle 22. The atomizing spool 21 is matched with the cavity 29 of nozzle 22 by means of interference fit, and the atomizing channel 26 is matched with the nozzle 22 by means of coaxial round cavity 27.

The drink means includes a movable rubber plug 6 and the water outlet means 7. When the movable rubber plug 6 moves up and down along the water outlet means 7, a plastic wall 61 of the movable rubber plug 6 connects and detach with the outlet in outlet means 7, so as to open or close the water outlet 90. In detail, a gap 71 is formed between the water outlet means 7 and the movable rubber plug 6. When the movable rubber plug 6 moves up along the water outlet means 7, the plastic wall 61 of the movable rubber plug 6 connects with the water outlet 90, and the water inside the elastic deformation bottle pours out along the gap 71.

The water locking means includes a fixing part 40 and a movable part 80 rotating relative to fixing part 40. The fixing part 40 includes a tube located axially in the center of cap body 1, and the bottom of the tube is closed and a cylindric protuberance 42 is disposed inside the bottom of the tube. A first outlet 44 is disposed on the sidewall of the tube adjacent to the closing bottom. The movable part 80 of water locking means is in a shape of a right angle, and includes a first connecting tube 70 in a vertical direction, and a second connecting tube 31 in a horizontal direction. The first connecting tube 70 is integrated with the second connecting tube 31. The first connection tube 70 is connected to the fixing part 40 of the water locking means by means of liquid-tight fit. The movable part 80 rotates relative to the fixing part 40 around an axis of the first connecting tube 70. A receiving space is located on the second connecting tube 31, and the spray means is secured in the receiving space by means of interference and liquid-tight fit. The fixing part 40 of the water locking means includes a cylindrical protuberance 42 located on an interior of a bottom of the fixing part 40. The cylindrical protuberance 42 engages with the bottom of the movable part 80 of the water locking means. A first inlet 30 is defined at the bottom of the first connecting tube 70 corresponding to first outlet 44 of the tube of the fixing part 40, and the movable part 80 rotates relative to fixing part 40 pursuant to tube as axis to fulfill butt joint or interleaving of the first outlet 44 and the first inlet 30, and thus to fulfill opening or closing of the spray means 2. A support bracket 43 supporting atomizing spool 21 is disposed inside the receiving space . The support bracket 43 is used to support the atomizing spool 21. In order to strengthen the liquid-tight effect between the first connecting tube 70 of the movable part 80 and the tube of fixing part 40, an annular groove 41 is disposed on the inner wall of tube of fixing part 40 of water locking means, and an annular protuberance 39 is disposed on the movable part 80 of the water locking means, which is matched with groove 41 on the inner wall of tube of fixing part 40.

An on-off position means is located on an end surface of the cap body 1, and the on-off position means includes a pair of position blocks 33, 36 respectively fixing the spray means on 0° and 90° positions. The pair of positioning blocks 33, 36 are configured to fix the water locking means in an open position and in a close position, respectively. Each one of the positioning blocks 33, 36 includes a cambered surface 34 matched with the second connecting tube 31.

A limiting protuberance 35 is disposed on one side of a bottom of the cambered surface 34 of one of the positioning blocks 33, 36, and the one of the positioning blocks 33, 36 corresponds to the close position of the water locking means, and the limiting protuberance 35 fixes the water locking means in the close position.

### Embodiment 2

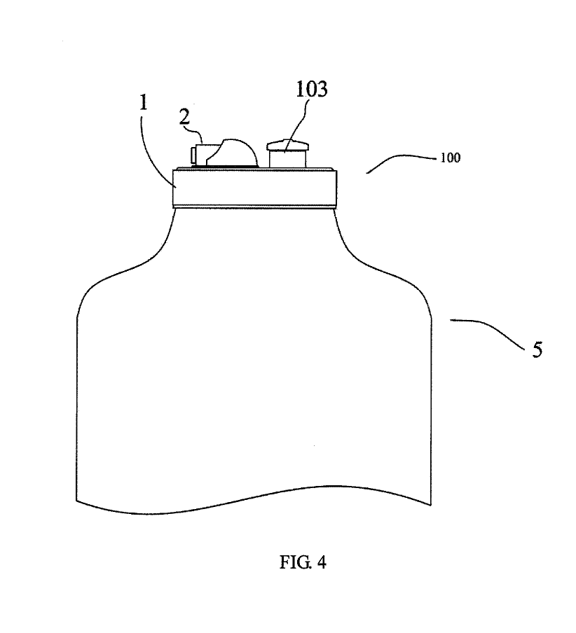

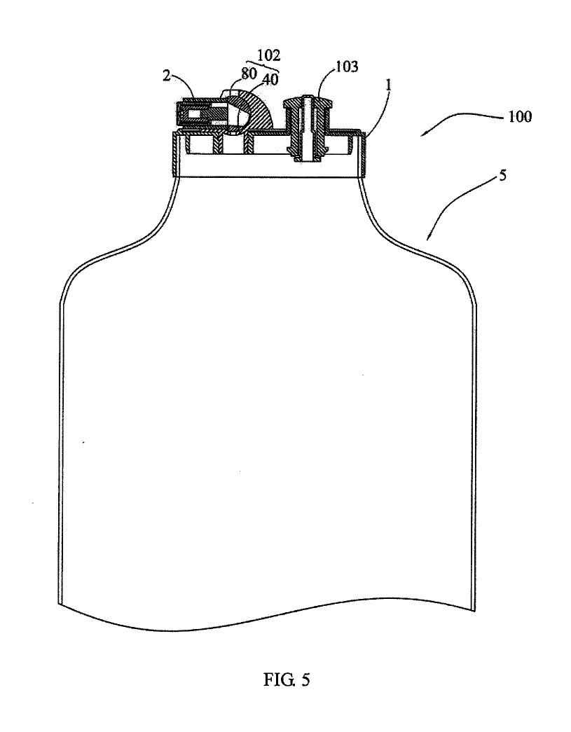

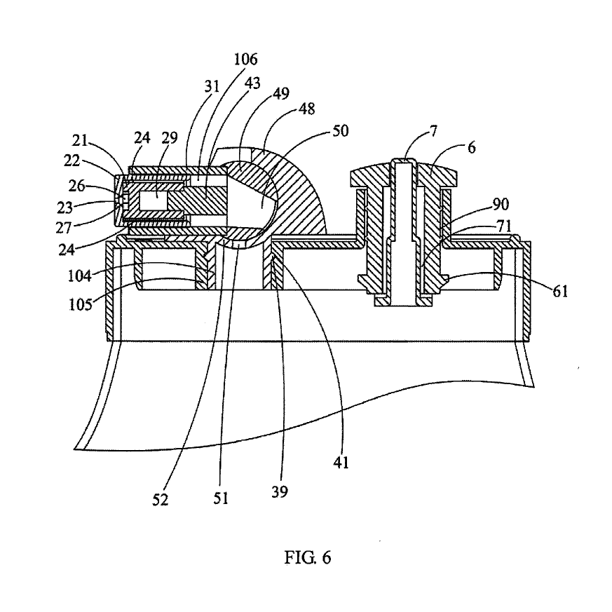

With reference to FIGS. 4-6, a sport-type multifunctional spray mineral water bottle includes an elastic deformation bottle 5 and a spray mineral water bottle cap 100. The spray mineral water bottle cap 100 includes a cap body 1, a spray means 2 and a water locking means 102 and a drink means 103. The spray means 2 includes atomizing spool 21 and nozzle 22, and at least two water channels 24 are disposed on the outer wall of atomizing spool 21, and the number of water channels 24 can be increased pursuant to the water volume. An atomizing channel 26 corresponding to the water channels 24 is disposed on the end face of atomizing spool 21. The water channels 24 and the atomizing channel 26 are connected by means of two connecting channels. A cavity 29 is defined in nozzle 22 to hold the atomizing spool 21. A spray aperture 23 is defined on the end face of one end of the nozzle 22. The atomizing spool 21 is matched with the cavity 29 of nozzle 22 by means of interference fit, and the atomizing channel 26 communicates with the spray aperture 23 of the nozzle 22 by means of a coaxial round cavity 27.

The drink means 103 includes a movable rubber plug 6 and the water outlet means 7. When the movable rubber plug 6 moves up and down along the water outlet means 7, a plastic wall 61 of the movable rubber plug 6 connects and detach with the outlet in outlet means 7, so as to open or close the water outlet 90. In detail, a gap 71 is formed between the water outlet means 7 and the movable rubber plug 6. When the movable rubber plug 6 moves up along the water outlet means 7, the plastic wall 61 of the movable rubber plug 6 connects with the water outlet 90, and the water inside the elastic deformation bottle pours out along the gap 71.

The water locking means 102 includes a fixing part 40 and a movable part 80 rotating relative to the fixing part 40. The fixing part 40 is fixed with the cap body 1 and defines a first outlet 51. The movable part 80 defines a first inlet 50 corresponding to the first outlet 51 of fixing part 40. The movable part 80 rotates relative to the fixing part 40 back and forth to result the first outlet 51 of the fixing part 40 to align the first inlet 50 of the movable part 80 or interleaving between the first outlet 51 of the fixing part 40 and the first inlet 50 of the movable part 80, thus achieving the opening or closing of the spray means 2. The movable part 80 defines a receiving space 106 securing the spray means 2 by way of interference fit.

In the embodiment, the fixing part 40 of the water locking means 102 is fixed with the cap body 1, and includes a spherical working face 52. The first outlet 51 is defined on the spherical working face 52. The movable part 80 includes a sphere 49 matched with the spherical working face 52 by means of liquid-tight fit. The sphere 49 is rotatably connected with the fixing part 40. The first inlet 50 is defined on the sphere 49 along a rotating track of the first outlet 51 on the spherical working face 52.

The movable part 80 further includes a first tube 31 extending from the sphere 49, the receiving space 106 is defined in the first tube 31 and communicates with the first inlet 50 of the movable part 80.

In the embodiment, the cap body 1 includes a second tube 105 projecting from an interior surface of the end face of the cap body 1. The fixing part 40 includes a third tube 104 projecting from the spherical working face 52 and sleeved in the second tube 105. The third tube 104 communicates with the outlet aperture of the cap body 1 and the first outlet 51 of the fixing part 40.

The second tube 105 defines an annular groove 41 on an inner wall of the second tube 105. The third tube 104 includes an annular protuberance 39 projecting from an exterior surface of the third tube 104 and engaging with the annular groove 41 on the inner wall of the second tube 105 of the cap body 1.

In the embodiment, the fixing part 40 of the water locking means 102 includes a position means 48 located on the end face of the cap body 1. The position means 48 is configured for opening and closing the movable part 80, and allows the movable part 80 to rotate within a specified radian of 90° degrees.

A supporting bracket 43 projects from an interior surface of movable part 80, and extends into the cavity 29 of the nozzle 22 to support the atomizing spool 21.

### Embodiment 3

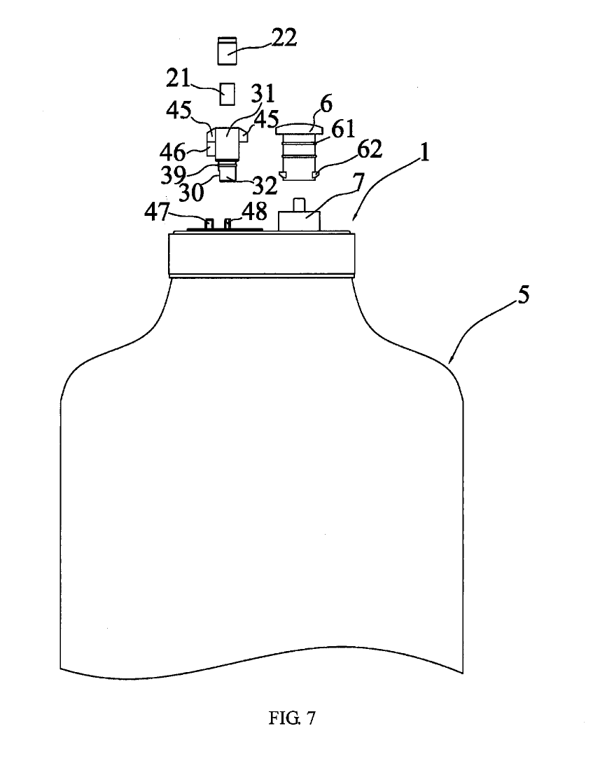

As shown in FIG. 7, A sport-type multifunctional spray mineral water bottle, including an elastic deformation bottle 5 and a spray mineral water bottle cap, wherein the spray mineral water bottle cap has ready described clearly in embodiment 1, hereinafter is not be repeated here. In comparison with the right angle shaped movable part of water locking means in the embodiment 1, the movable part of water locking means in embodiment 2 is straight line shape, including movable part tube 31 and tube 32, wherein tube 32 is sleeve jointed inside the fixing part tube in the embodiment 1, annular protuberance 39 is matched with annular groove, the bottom port of tube 32 is matched with cylindric protuberance at the bottom of the fixing part tube, the movable part rotates relative to the fixing part back and forth to fulfill the butt joint or interleaving between inlet 30 and outlet, thus achieving the opening and closing of the spray means. A cavity is disposed inside tube 31, atomizing spool 21 is sleeve jointed to the cavity of the nozzle to form spray means 2, and the spray means is sleeve jointed to the cavity of tube 31. To facilitate rotation of the movable part of water locking means, rotating handles 45 are disposed at both sides of upper end of tube 31. On-off position means is disposed between the middle of tube 31 and end face of cap body 1, and this position means includes position blocks 47 and 48 respectively fixed on 0° and 90° positions of end face of cap body and limiting stopper 46 fixed on the corresponding position of the movable part.

The drink means includes a movable rubber plug 6 and the water outlet means 7, wherein when the movable rubber plug 6 moves up and down along the water outlet means 7, the plastic wall 61 in the movable rubber plug 6 connects and detach with the outlet in outlet means 7, so as to open or close the water outlet.

With the coordination of the elastic mineral water boty and the capy, the spray mineral water of the invention can ensure normal drinking of mineral water as well as carry out spray drinking of water by means of squeezing the bottle body to transform bottle body and increase the pressure inside, thus making water to enter inlet from the outlet of water locking means on the cap, and to enter the atomizing channel through the water channel, finally to be sprayed from the spray aperture. Furthermore, in the open air or in the dusty and hot environment, you can place the mineral water bottle upside down, put the nozzle to face your body or surrounding, and squeeze the bottle body to spray, thus reducing surrounding temperature, as well as subsiding dust by combining dust and spray to make you feel cool, fresh and comfortable. This invention features in simple structure and strong practicability, so it has promising market prospect.

The foregoing descriptions of the embodiments and their accompanying drawings of the invention are intended to illustrate and not to limit this invention. Various changes and modifications may be made to the embodiments without departing from the spirit of the invention. Therefore, the scope of the invention is to be limited only by the appended claims.

What is claimed is:

1. A mineral water bottle, comprising an elastic deformation bottle and a spray mineral water bottle cap, characterized in that the spray mineral water bottle cap comprises:
a cap body secured on a bottleneck of the mineral water bottle and covering an open of the mineral water bottle, wherein the cap body defines an outlet aperture on an end face of the cap body;
a drink means comprising a movable rubber plug, and wherein the cap body defines a water outlet, and the movable rubber plug moves along the water outlet to open or close the water outlet;
a spray means comprising an atomizing spool and a nozzle, wherein at least two water channels are defined on the outer wall of the atomizing spool, and an atomizing channel is defined on an end face of the water channels, and correspond to the water channels;
and wherein the nozzle defines a cavity to receive the atomizing spool, and a spray aperture is defined on an end face of the nozzle; and wherein the atomizing spool matches with the cavity of the nozzle by interference fit, and the atomizing channel communicates with the nozzle; and
a water locking means comprising a fixing part and a movable part rotating relative to the fixing part, and wherein the fixing part is fixed with the cap body and defines a first outlet; and wherein the movable part defines a first inlet corresponding to the first outlet of fixing part; and wherein the movable part rotates relative to the fixing part back and forth to result the first outlet of the fixing part to align the first inlet of the movable part or interleaving between the first outlet of the fixing part and the first inlet of the movable part, thus achieving the opening or closing of the spray means; and the movable part defines a receiving space securing the spray means by way of interference fit;
wherein the elastic deformation bottle is squeezed to increase the pressure inside the elastic deformation bottle, water inside the elastic deformation bottle enters the first inlet of the movable part from the first outlet of the fixing part, and then enters the atomizing channels through the water channels, finally sprays out from the spray aperture.

2. The mineral water bottle of claim 1, wherein the fixing part of water locking means is fixed with the cap body, the fixing part comprises a spherical working face, and the first outlet is defined on the spherical working face; and wherein the movable part comprises a sphere matched with the spherical working face by means of liquid-tight fit, and the sphere is rotatably connected with the fixing part, and wherein the first inlet is defined on the sphere along a rotating track of the first outlet on the spherical working face.

3. The mineral water bottle of claim 2, wherein the movable part further comprises a first tube extending from the sphere, the receiving space is defined in the first tube and communicates with the first inlet.

4. The mineral water bottle of claim 2, wherein the cap body comprises a second tube projecting from an interior surface of the end face of the cap body, and the fixing part comprises a third tube projecting from the spherical working face and sleeved in the second tube, and the third tube communicates with the outlet aperture of the cap body and the first outlet of the fixing part.

5. The mineral water bottle of claim 4, wherein the second tube defines an annular groove on an inner wall of the second tube, and the third tube comprises an annular protuberance projecting from an exterior surface of the third tube and engaging with the annular groove on the inner wall of the second tube of the cap body.

6. The mineral water bottle of claim 1, wherein the fixing part of the water locking means comprises a position means located on the end face of the cap body, the position means is configured for opening and closing the movable part, and allows the movable part to rotate within a specified radian of 90° degrees.

7. The mineral bottle of claim 3, wherein a supporting bracket projects from an interior surface of the receiving space of the first tube, and extends into the cavity of the nozzle to support the atomizing spool.

8. The mineral bottle of claim 1, wherein the drink means further comprises a water outlet means fixed with the cap body, a gap is formed between the water outlet means and the movable rubber plug, and the movable rubber plug comprises a plastic wall, and wherein when the movable rubber plug moves up along the water outlet means, the plastic wall of the movable rubber plug connects with the water outlet, and the water inside the elastic deformation bottle pours out along the gap.
